(19) United States
(12) Patent Application Publication
(10) Pub. No.: US 2005/0041980 A1
(43) Pub. Date: Feb. 24, 2005

(54) Wireless optical system

(75) Inventors: Kiichi Ueyanagi, Kanagawa (JP); Yukio Adachi, Kanagawa (JP); Yasuji Seko, Kanagawa (JP); Hiroyuki Hotta, Kanagawa (JP); Takashi Ozawa, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/784,869

(22) Filed: Feb. 24, 2004

(30) Foreign Application Priority Data
Aug. 18, 2003 (JP) 2003-294080
Aug. 18, 2003 (JP) 2003-294081

(51) Int. Cl. H04B 10/00

(52) U.S. Cl. 398/156

(57) ABSTRACT

A master device and a slave device are each constituted of a transmitting section; a receiving section; and a control section including a three-dimensional position calculation section for calculating a three-dimensional position of the transmitting section of the counterpart master device or that of the counterpart slave device and an element drive section for driving an MEMS element. First, the master device outputs transmission light having comparatively narrow directivity, and the transmission light is two-dimensionally scanned. Next, the receiving section of the slave device receives that transmission light, calculates the transmission direction of the master device from the position of a spot of transmitted light on a light-detecting element array, and transmits the transmission light in that direction. At this point in time, scanning of the transmission light from the master device is stopped, and subsequently communication is initiated.

### BACKGROUND OF THE INVENTION

1. Field of the Invention

The present invention relates to a wireless optical system which transmits and receives an information signal to and from a device in communication therewith, as well as to a wireless optical system which transmits and receives an information signal between a master device and a slave device. More particularly, the present invention relates to the wireless optical system and the wireless optical system which attempt to attain compactness and low power consumption and can be applied to a mobile equipment.

2. Description of the Related Art

Like radio communication, optical wireless communication does not require any wiring, and, unlike radio communication, optical wireless communication comparatively readily enables high-speed communication at 100 Mbps or higher. Therefore, optical wireless communication is considered a potential technique for linking a LAN with fixed or semi-fixed equipment, such as a personal computer or a printer, or mobile equipment, such as PDA (Personal Data Assistance) equipment. The fixed or semi-fixed equipment and the mobile equipment are desired to be compact to such an extent that an optical wireless device can be attached to the equipment, and are desired to be power thrifty. In particular, ability to effect transmission and reception over a long period of time through single recharging operation is an important consideration in optical wireless communication of mobile equipment, and minimizing power consumption is of importance. Further, in accordance with an increase in resolution of an image or the volume of motion picture data, high-speed communication of 100 Mbps or more; if practicable, high-speed communication of 1 Gpbs, is sought. For these reasons, an increase in a received input is required, and realization of efficient transmission/reception has arisen as a challenge to be met. With the aim of solving challenges and problems of the mobile equipment, many optical communication techniques have hitherto been developed with particular emphasis on IrDA (Infrared Data Communication), which is the standard requirement for optical communication. Long ago, there was developed an optical communication which establishes communication by means of linking a master device with a slave device through use of a beam having a wide directional angle or a beam having a narrow directional angle. In the former case (i.e., optical communication having a wide directional angle), a transmission output must be increased in order to process a signal while maintaining a sufficient signal-to-noise ratio. In the latter case (i.e., optical communication having a narrow directional angle), transmission can be effected at low power. However, manual directional settings are required. Moreover, when the slave device is moved, maintenance of connection with the slave device is difficult. Thus, difficulty is encountered in applying the optical communication technique to the mobile equipment.

Subsequently, there has been developed an optical wireless system comprising: a transmitter having a first light-emitting element for outputting first transmission light having a narrow directional angle and a second light-emitting element for outputting second transmission light having a wide directional angle; a receiver having a light-detecting element; and a monitoring TV for displaying the intensity of the light received by the receiver. In such a system, the transmitter and the receiver are perceived by means of the second transmission light having a wide directional angle, and initiation of transmission and reception operations is made feasible. Subsequently, transmission and reception operations are performed by means of the first transmission light having a narrow directional angle (see, e.g., JP-A-6-232818 (FIG. 1)).

As another example, there has already been developed and put into practice an optical wireless system, wherein transmission light having wide directivity is transmitted from a master device; a receiving element and a transmission element are arranged side by side in a slave device; the master device is sought by simultaneously, two-dimensionally scanning the receiving and transmission elements; transmission light output from the master device is received; and transmission is effected in that direction. In this example, transmission light of the master device has a wide directional angle. Therefore, when a plurality of slave devices are present, transmission light from the master device simultaneously falls on receiving sections of a plurality of slave devices. This is suitable for a situation in which simultaneous transmission of a single signal to a plurality of slave devices operated by students in a classroom or the like. In the case of a slave device, a transmission element and a receiving element, which have separate condenser lenses, are arranged side by side on a single holder. Orientation of the slave device is two-dimensionally adjusted by means of rotation of a motor attached to the holder.

However, according to the related-art optical wireless system, when the slave device moves, difficulty is encountered in maintaining connection with the master device. A large output is required at the initiation of transmission. A device and signal processing become complicated. Therefore, there has been a problem of difficulty in using the optical wireless system for mobile equipment. The master device which transmits transmission light having wide directivity is suitable for, e.g., a case where a single signal is transmitted to a plurality of slave devices operated by pupils in a classroom. However, when different signals are transmitted to a plurality of slave devices in an office or the like, respective slave devices must perceive the master device, and communication must be established with the slave devices in the manner of time division. Thus, there is a problem of the uploading speed of a signal from the slave device decreasing in inverse proportion to the number of slave devices. Further, according to the related-art optical wireless system, in which the transmission element and the receiving element, the elements having different condenser lenses, are disposed side by side on a single holder and orientation of the system is two-dimensionally adjusted by means of rotation of the motor attached to the holder, the slave device assumes a size of about 10 cm or more, and power consumption becomes very large, on the order of 2 watts or thereabouts. Therefore, there arises a problem of difficulty in employing the optical wireless system for mobile equipment.

### SUMMARY OF THE INVENTION

The object of the present invention is to provide an optical wireless device and an optical wireless system which are applicable to a mobile equipment, and are more compact and achieve lower power consumption.

The invention provides a wireless optical system which has a transmitting section having a light-emitting element and a transmission light condenser lens, and a receiving section having a light-detecting element and a received light condenser lens, and which communicates with a counterpart device, the wireless optical system further having: scanning means which two-dimensionally scans said light-emitting element relative to said transmission light condenser lens; and control means which controls a transmission direction of transmission light transmitted from said light-emitting element by driving said scanning means.

The invention also provides a wireless optical system which has a transmitting section having a light-emitting element and a transmission light condenser lens, and a receiving section having a light-detecting element and a received light condenser lens, and which communicates with a counterpart device, the wireless optical system further having: scanning means which two-dimensionally scans said light-detecting element relative to said received light condenser lens; and control means which controls a reception direction of received light received by said light-detecting element by driving said scanning means.

The invention also provides a wireless optical system which has a transmitting section having a light-emitting element and a transmission light condenser lens, and a receiving section having a light-detecting element and a received light condenser lens, and which communicates with a counterpart device, the wireless optical system further having: scanning means which two-dimensionally scans said light-emitting element relative to said transmission light condenser lens, and two-dimensionally scans said light-detecting element relative to said received light condenser lens; and control means which controls a transmission direction of transmission light transmitted from said light-emitting element by driving said scanning means, and controls a reception direction of received light received by said light-detecting element by driving said scanning means.

The invention also provides a optical wireless system which communicates between a master device and a slave device, wherein said master device and said slave device respectively has a transmitting section having a light-emitting element and a transmission light condenser lens, and a receiving section having a light-detecting element and a received-light condenser lens, and at least one of said master device and said slave device has: scanning means which two-dimensionally scans said light-emitting element relative to said transmission light condenser lens, and two-dimensionally scans said light-detecting element relative to said received light condenser lens; measuring means which measures a transmission direction of the transmission light transmitted from said master device or said slave device on the other end; and control means which drives said scanning means to control a transmission direction of the transmission light transmitted from said light-emitting element and a reception direction of the received light received by said light-detecting element based on measurement result of said measuring means.

According to the optical wireless device and system of the invention, in the transmitting section or the receiving section, only the light-emitting element or the light-detecting element is two-dimensionally scanned relative to the condenser lens. As a result, a movable section can be significantly miniaturized, and the optical wireless device and system can be significantly miniaturized. High-speed scanning also becomes feasible. Moreover, as a result of scanning of the light-emitting element and the light-detecting element, the quantity of light entering the receiving element can be increased by the transmission light of a narrow directional angle as well. Transmission and reception can be performed with low power consumption. Accordingly, the optical wireless device and system become applicable to mobile equipment.

The invention also provides wireless optical system which has a transmitting section having a light-emitting element and a transmission light condenser lens, and a receiving section having a light-detecting element and a received light condenser lens, and which communicates with a counterpart device, the wireless optical system further having: scanning means which scans said light-emitting element relative to said transmission light condenser lens; and control means which controls a transmission direction of transmission light transmitted from said light-emitting element by driving said scanning means.

The invention also provides wireless optical system which has a transmitting section having a light-emitting element and a transmission light condenser lens, and a receiving section having a light-detecting element and a received light condenser lens, and which communicates with a counterpart device, the wireless optical system further having: scanning means which scans said light-detecting element relative to said received light condenser lens; and control means which controls a reception direction of received light received by said light-detecting element by driving said scanning means.

The invention also provides wireless optical system which has a transmitting section having a light-emitting element and a transmission light condenser lens, and a receiving section having a light-detecting element and a received light condenser lens, and which communicates with a counterpart device, the wireless optical system further having: scanning means which scans said light-emitting element relative to said transmission light condenser lens, and scans said light-detecting element relative to said received light condenser lens; and control means which controls a transmission direction of transmission light transmitted from said light-emitting element by driving said scanning means, and controls a reception direction of received light received by said light-detecting element by driving said scanning means.

The invention also provides optical wireless system which communicates between a master device and a slave device, wherein said master device and said slave device respectively has a transmitting section having a light-emitting element and a transmission light condenser lens, and a receiving section having a light-detecting element and a received-light condenser lens, and at least one of said master device and said slave device has: scanning means which scans said light-emitting element relative to said transmission light condenser lens, and scans said light-detecting element relative to said received light condenser lens; and control means which drives said scanning means to control said transmission direction of the transmission light transmitted from said light-emitting element and a reception direction of the received light received by said light-detecting element.

According to the wireless optical system and system of the present invention, a transmitting section or a receiving section scans only a light-emitting element or a light-detecting element relative to a condenser lens, thereby enabling significant miniaturization of a movable section. The wireless optical system and system can be significantly miniaturized, and high-speed scanning also becomes possible. Moreover, by means of scanning of the light-emitting element and the light-detecting element, the quantity of light entering the receiving element can be increased, whereby transmission and reception can be performed with low power consumption. Accordingly, the wireless optical system can be applied to mobile equipment.

### BRIEF DESCRIPTION OF THE DRAWINGS

FIG. 1 is a view showing an optical wireless system according to a first embodiment of the present invention;

FIG. 2 is a schematic cross-sectional view of a slave device equipped with a transmission/receiving section of the first embodiment;

FIG. 3 is a cross-sectional view of a transmitting section of the slave device of the first embodiment;

FIG. 4A is a plan view showing the featured section of an MEMS element shown in FIG. 3;

FIG. 4B is an enlarged plan view of a saw-toothed drive element of the MEMS element;

FIG. 5 is a cross-sectional view of a receiving section of the slave device of the first embodiment;

FIG. 6 is a plan view showing the light-detecting element shown in FIG. 5;

FIG. 7 is a cross-sectional view of the receiving section of a slave device according to a second embodiment of the present invention;

FIG. 8 is a schematic plan view of an optical wireless device according to a third embodiment of the present invention;

FIGS. 9A and 9B are views showing a wireless optical system according to a fourth embodiment of the present invention, wherein FIG. 9A is a view showing a state achieved at the time of initiation of transmission and reception and FIG. 9B is a view showing a state achieved during the course of continuous transmission and reception;

FIG. 10 is a schematic cross-sectional profile of a slave device of the fourth embodiment;

FIG. 11 is a cross-sectional view profile of a transmitting section of the slave device of the fourth embodiment;

FIG. 12A is a plan view showing the principal feature of an MEMS element shown in FIG. 11;

FIG. 12B is an enlarged plan view of a saw-toothed drive element of the MEMS element;

FIG. 13 is a cross-sectional profile of a receiving section of the slave device of the fourth embodiment;

FIG. 14 is a plan view showing a light-detecting element of the light-detecting section of the fourth embodiment; and

FIG. 15 is a schematic plan view of a wireless optical system according to a fifth embodiment of the present invention.

### DETAILED DESCRIPTION OF THE PREFERRED EMBODIMENTS

(First Embodiment)

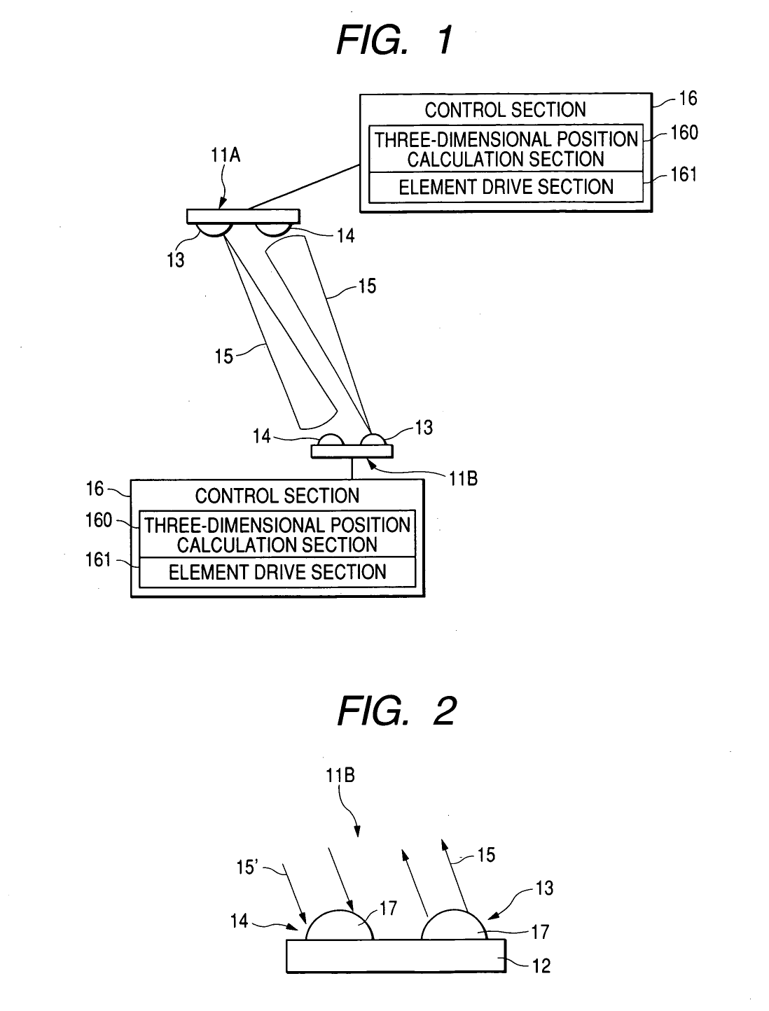

FIG. 1 shows an optical wireless system according to a first embodiment of the invention. The optical wireless system of the first embodiment transmits and receives an information signal between a master device 11A serving as an optical wireless device and a slave device 11B serving as another optical wireless device. The master device 11A and the slave device 11B have identical configurations. They are respectively configured to have a transmitting section 13, a receiving section 14, and a control section 16 including a three-dimensional position calculation section 160 for calculating a three-dimensional position of the transmitting section 13 of the master device 11A or the slave device 11B on the other end and an element drive section 161 for driving an MEMS (Micro Electro-Mechanical System) element to be described later.

As shown in FIG. 1, at the time of initiation of transmission and reception, the master device 11A transmits transmission light 15 having a comparatively narrow directivity, and the transmission light 15 is two-dimensionally scanned by means of the element drive section 16. Then, the receiving section 14 of the slave device 11B receives the transmission light 15, and the three-dimensional position calculation section 160 computes the transmission direction of the master device 11A from the position of a spot of the received light on a light-detecting element array to be described later, and transmits the transmission light 15 toward the thus-calculated direction. At this point in time, the master device 11A stops scanning of the transmission light 15 and subsequently starts transmission. When the receiving section 14 of the master device 11A has an arrayed light-detecting element as well, the master device 11A and the slave device 11B can detect transmission directions thereof. Each of the master and slave devices 11A, 11B independently transmits the transmission light 15 in the transmission direction of the counterpart device, to thereby establish communication.

FIG. 2 shows the slave device 11B of the first embodiment. As shown in FIG. 2, the slave device 11B has the transmitting section 13 and the receiving section 14 which are disposed on a substrate 12. The transmitting section 13 transmits the transmission light 15, and the receiving section 14 receives the received light 15′. In the slave device 11B, the diameter of the transmitting section 13 and that of the receiving section 14 are set to 5 mm, in order to attain miniaturization. In the master device 11A, the diameter of the transmitting section 13 and that of the receiving section 14 are set to about 20 mm, in order to enhance converging efficiency. In each of the respective devices 11A and 11B, the transmitting section 13 and the receiving section 14 are placed on the substrate 12 while being separated from each other by a distance essentially equal to the respective diameter.

FIG. 3 shows the transmitting section 13 of the slave device 11B of the first embodiment. As shown in FIG. 3, the transmitting section 13 has a light-emitting element 18 which is formed from a GaAs-based semiconductor laser and disposed in the vicinity of the position of a focal point of a condenser lens 17. In the condenser lens 17, both a plane of incidence and a plane of exit are formed as aspheric surfaces. Aberration of the planes is abated, thereby imparting an essentially-Gaussian-shaped distribution to the transmission light 15. Further, the light-emitting element 18 is provided on an MEMS (Micro Electrical-Mechanical System) element 19 which can be electro-statically, two-dimensionally scanned and is subjected to a two-dimensional scan. A holder section 115 is provided on a part of the substrate 12 and retains the condenser lens 17, the MEMS element 19, or the like.

A GaAs VCSEL (Vertical Resonance Surface-Emitting Laser) having a wavelength of 1.4 to 1.6 μm is used for the light-emitting element 18 of the slave device 11B. An InGaAs LD (End-Face-Emitting Laser) which oscillates at a wavelength of 980 nm is used for the light-emitting element 18 of the master device 11A. An active layer of the VCSEL of the slave device 11B has a comparatively large diameter on the order of 10 μm. Although the VCSEL performs multimode oscillation, a large output; e.g., an output of 10 mW or more, can be produced. In order to curtail costs, an LD for fiber amplification purpose is used as the LD of the master device 11A. As a result of the transmission wavelength of the master device 11A and that of the slave device 11B having been made different from each other, the laser lights emitted from these devices can be separated from each other through use of simple color glass. The light-emitting element 18 of the slave device 11B is mounted on the MEMS element 19 capable of scanning in two dimensions 12, that is, directions X and Y. As a result, the transmission light source can be two-dimensionally scanned.

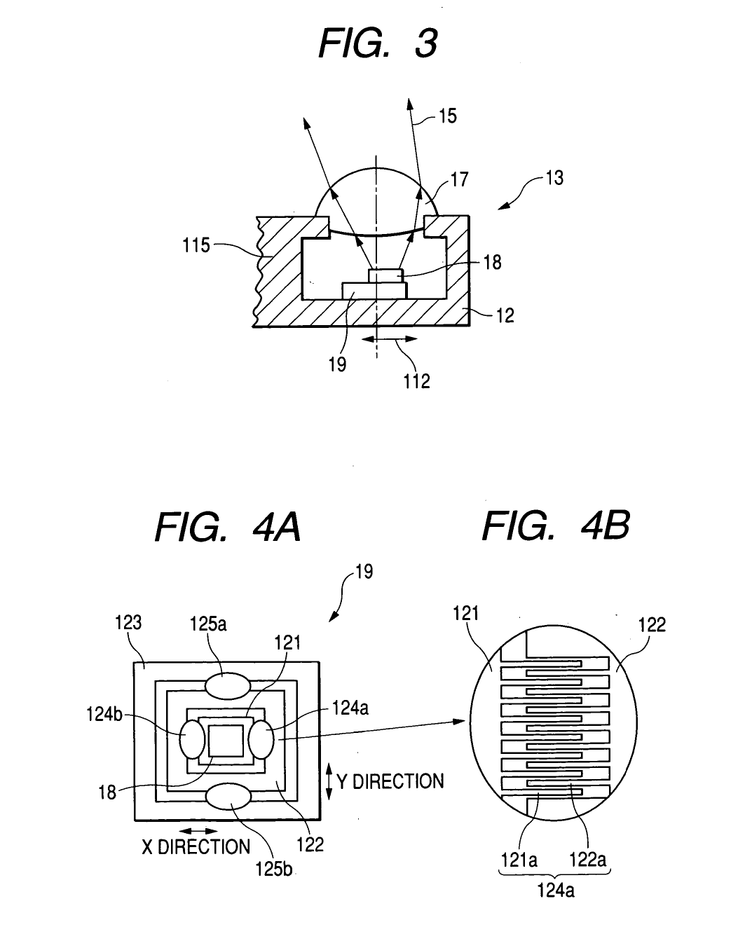

FIG. 4A shows the principal feature of the MEMS (Micro Electro-Mechanical System) element 19. The MEMS element 19 has an MEMS substrate 123, a Y-direction movable section 122 which is movable in the direction Y with respect to the MEMS substrate 123, and an X-direction movable section 121 which is movable in the direction X with respect to the Y-direction movable section 122. The light-emitting element 18 is mounted at the center of the X-direction movable section 121. Saw-toothed drive elements 124a, 124b are disposed on the respective horizontal sides of the X-direction movable section 121 between the X-direction movable section 121 and the Y-direction movable section 122. Saw-toothed drive elements 125a, 125b are disposed on vertical sides of the Y-direction movable section 122 between the Y-direction movable section 122 and the MEMS substrate 123.

As shown in FIG. 4B, the saw-toothed drive element 124a is formed from a pair of saw-toothed electrodes 121a, 122a which extend in the X direction and have a width of 5 μm and a length of 150 μm. As a result of an electrostatic voltage being applied to the electrodes 121a, 122a, the saw-toothed drive element performs scanning in the X direction. The other saw-toothed drive element 124b is configured in the same manner as is the saw-toothed drive element 124a shown in FIG. 4B. As a result of an electrostatic voltage being applied to the electrodes, the saw-toothed drive element 124b performs scanning in the X direction. The saw-toothed electrode elements 125a, 125b are formed from a pair of saw-toothed electrodes which extend in the Y direction and have a width of 5 μm and a length of 150 μm. As a result of an electrostatic voltage being applied to the electrodes, the saw-toothed drive elements perform scanning in the Y direction. As a result of the light-emitting element 18 being actuated in the X and Y directions, the light-emitting element 18 is actuated over a distance of ±100 μm, and outgoing light is two-dimensionally scanned through an angle of 10° or thereabouts.

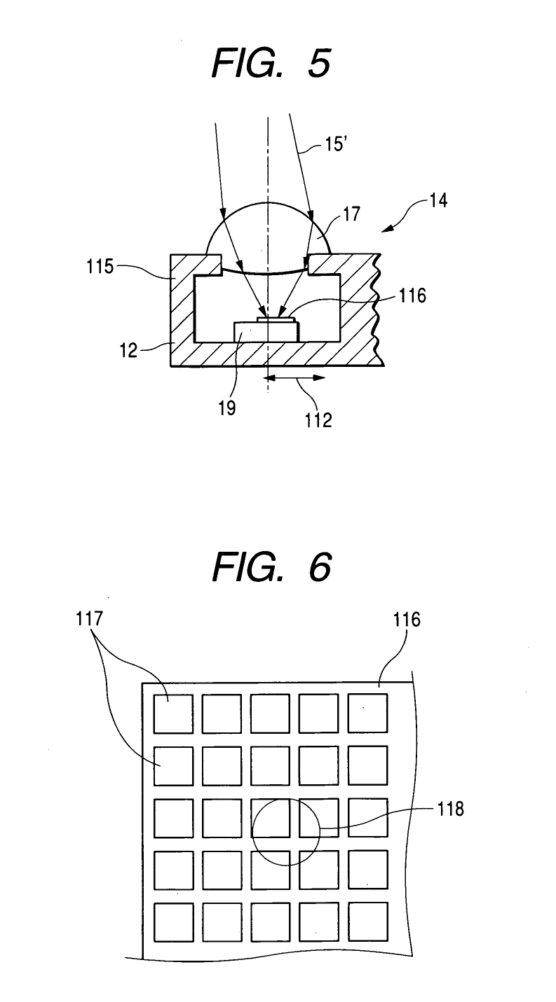

FIG. 5 shows the receiving section 14 of the slave device 11B of the first embodiment. As shown in FIG. 5, the receiving section 14 differs from the transmitting section shown in FIG. 3 only in that the light-emitting element 18 is replaced with a light-detecting element 116. In other respects, the receiving section 14 is configured in the same manner as is the transmitting section 13. The light-detecting element 116 formed from two-dimensional arrayed pin photodiodes is disposed in the vicinity of the focal point of the condenser lens 17 and on the MEMS element 19.

FIG. 6 shows the light-detecting element 116 shown in FIG. 5. The light-detecting element 116 is formed by means of arranging 20-by-20 pin photodiodes 117, each measuring 5 μsquare and serving as a light detection element, in a two-dimensional array. The position of a spot 118 of the received light 15′ converged on the light-detecting element 116 is detected on the basis of comparison between voltages output from the pin photodiodes 117 of the light-detecting element 116. As a result, the direction of the other transmission light 15 can be detected from the position of the received light 15′ on the light-detecting element 116 of the receiving section 14.

A distribution of intensity is measured by means of employing the array of the pin photodiodes 117 for the receiving section 14 of the master device 11A as well. The slave device 11B and the master device 11A periodically calculate the three-dimensional positions thereof. The light-detecting element 116 is positioned in the X and Y directions on the basis of the calculation results and scanned, whereupon the light is converted on one limited pin photodiode 117 (or a small number of pin photodiodes, such as two to four pin photodiodes) in the array. As a result, the master device 11A can track the movement or inclination of the slave device 11B. In order to detect movement, the transmission direction of one transmission light beam 15 is deflected at high speed, and the resultant deflection frequency is synchronously detected by the receiving section 14 on the other end, thereby calculating a moving direction. The emitting direction of the light-emitting element 18 is also controlled so that maximum sensitivity can be obtained at all times, by means of adjusting a transmission angle and a receiving angle.

In particular, when the slave device 11B has only one light detection element, the receiving section 14 of the master device 11A directs the transmission direction thereof toward the slave device 11B after having received the transmission direction of the slave device 11B, and sends a signal for correcting the transmission direction of the slave device 11B to the slave device 11B. Thereby, bi-directional communication is performed.

According to the first embodiment, only the light-emitting element 18 and the light-detecting element 116 are scanned while the condenser lens 17 remains fixed, thereby enabling a significant reduction in the size of a movable section. The wireless optical system can be significantly miniaturized to a size of 1 cm or less, and high-speed scanning also becomes feasible. Further, as a result of the master device 11A and the slave device 11B being enabled to transmit transmission light having a narrow directional angle, high-efficiency transmission and reception can be performed with low power consumption. Accordingly, the optical wireless device can be applied to mobile equipment.

(Second Embodiment)

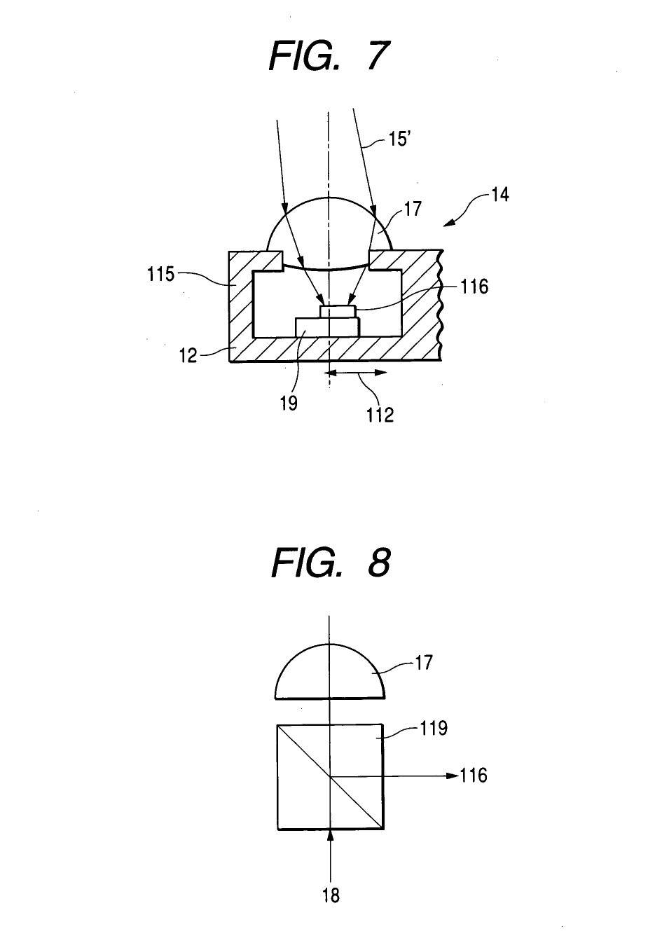

FIG. 7 shows the receiving section 14 of the slave device 11B according to a second embodiment of the present invention. As shown in FIG. 7, the receiving section 14 differs from the transmitting section 13 shown in FIG. 3 only in that the light-emitting element 18 is replaced with the light-detecting element 116. In other respects, the receiving section 14 is configured in the same manner as is the transmitting section 13. The light-detecting element 116 is disposed in the vicinity of the focal point of the condenser lens 17, and the single pin photodiode 117 is stacked on the MEMS element 19. The MEMS element 19 scans the light-detecting element 116 in directions 112 within two dimensions.

The size of the pin photodiode 117 is made substantially equal to the diameter of the optical spot 118 converted by the condenser lens 17. The position of the pin photodiode 117 is two-dimensionally wobbled, and the intensity of the received light 15′ is synchronously detected by means of the wobbling frequency, whereby the moving direction of the transmission light 15 can be detected. The transmission light 15 can be transmitted to that direction.

According to the second embodiment, the master device 11A and the slave device 11B can communicate with each other while each tracks the transmission direction of the transmission light 15 from the counterpart device.

(Third Embodiment)

FIG. 8 shows an optical wireless device according to a third embodiment of the present invention. The third embodiment is based on the first embodiment, wherein the light-emitting element 18 and the light-detecting element 116 are disposed in the vicinity of the condenser lens 17 so as to transmit and receive by way of a common beam splitter 119 and the common condenser lens 17. According to the third embodiment, the position of the light-emitting element 18 and that of the light-detecting element 116 are scanned with respect to the common condenser lens 17. The transmitting section and the receiving section are assembled into a single unit such that transmission is performed by controlling the transmitting and reception directions and the directional angle. As a result, the optical wireless device can be made compact to a much greater extent.

The present invention is not limited to the first to third embodiments set forth and is susceptible to various modifications. For instance, in the embodiments, the light-emitting element 18 is electro-statically scanned. However, if the MEMS element 19 is equipped with an electromagnet, the light-emitting element 18 may be electro-magnetically scanned. Alternatively, the light-emitting element 18 and the light-detecting element 116 may be supported through use of four narrow plate springs, which are used for automatic focus control and tracking in a pickup for use with an optical disk, in place of the MEMS element 19, and electro-magnetically scanned. As a result, scanning can be performed over hundreds of micrometers, and the directional angle can be changed significantly. Even when a large-diameter lens is used, a receiving angle can be scanned at a sufficient angle, and high-sensitivity receiving becomes feasible.

Although the pin photodiode array is used as the light-detecting element 116 in the embodiments, the light-detecting element is not limited to this. For instance, an avalanche photodiode, a CCD (Charge-Coupled Device) array, or an MOS (Metal Oxide Semiconductor) type receiving element may also be used, thereby enabling an attempt to curtail costs. However, in this case, signal processing is required to be carried out on a per-row basis in order to achieve enhanced speed.

The condenser lens 17 may be shifted with respect to the light-emitting element 18 or the light-detecting element 116.

The light-detecting element 116 may be configured from a pair of light detection elements which are disposed in the vicinity of the focal point of the condenser lens 17 and are substantially equal in size to the diameter of a converged spot. In this case, the position of the counterpart device is calculated from a difference between outputs from the pair of light detection elements.

According to the above embodiments, the master device 11A and the slave device 11B can communicate while each controls a direction of the transmission light beam 15 output from the counterpart device.Therefore, these can be applied to high-speed communication of mobile equipment such as a PDA or a portable cellular phone.

(Fourth Embodiment)

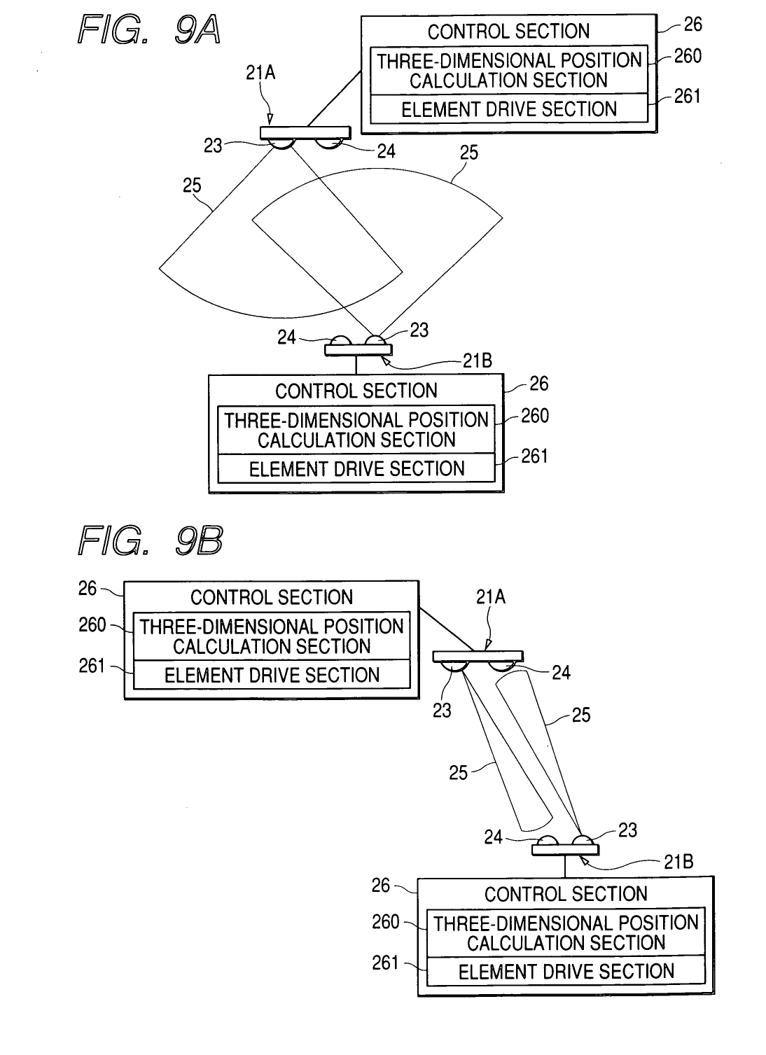

FIGS. 9A and 9B show optical wireless system according to a fourth embodiment of the invention. The optical wireless system of the fourth embodiment transmits and receives an information signal between a master device 21A serving as an optical wireless device and a slave device 21B serving as another optical wireless device. The master device 21A and the slave device 21B have identical configurations. They are respectively configured to have a transmitting section 23, a receiving section 24, and a control section 26 including a three-dimensional position calculation section 260 for calculating a three-dimensional position of the transmitting section 23 of the master device 21A or the slave device 21B on the other end and an element drive section 261 for driving an MEMS (Micro Electro-Mechanical System) element to be described later.

FIG. 9A shows a state in which transmission and reception operations are initiated, and FIG. 9B shows a state in which the transmission and reception operations are being performed continuously. As shown in FIG. 9A, at the time of initiation of transmission and reception operations, a transmitting section 23 of a master device 21A or that of a slave device 21B transmits a transmission light 25 having wide directivity. A receiving section 24 of the slave device 21B or that of the master device 21A receives the transmission light 25, thereby identifying the master device 21A or the slave device 21B on the other end. Next, as shown in FIG. 9B, the directional angle of the transmission light 25 is narrowed, and a three-dimensional position calculation section 260 of a control section 26 computes a three-dimensional position of the transmitting section 23 of the master device 21A or the slave device 21B on the other end based on the distribution of intensity of received light. On the basis of the result of computation, the control section 26 scans the positions of the light sources of the respective transmitting sections 23 through use of an MEMS element to be described later or the like, and adjusts the transmission direction toward the receiving section 24 on the other end. Subsequently, communication starts. Further, mutual three-dimensional positions are periodically computed, thereby causing the master device to track movement or inclination of the slave device 21B. In order to detect movement, the transmission direction of the transmission light 25 output from one end is repeatedly deflected at minute angles, and a deflection frequency of the transmission light is synchronously detected by the receiving section 24 on the other end, thereby computing a moving direction. A transmission angle and a receiving angle are adjusted such that maximum sensitivity is obtained at all times.

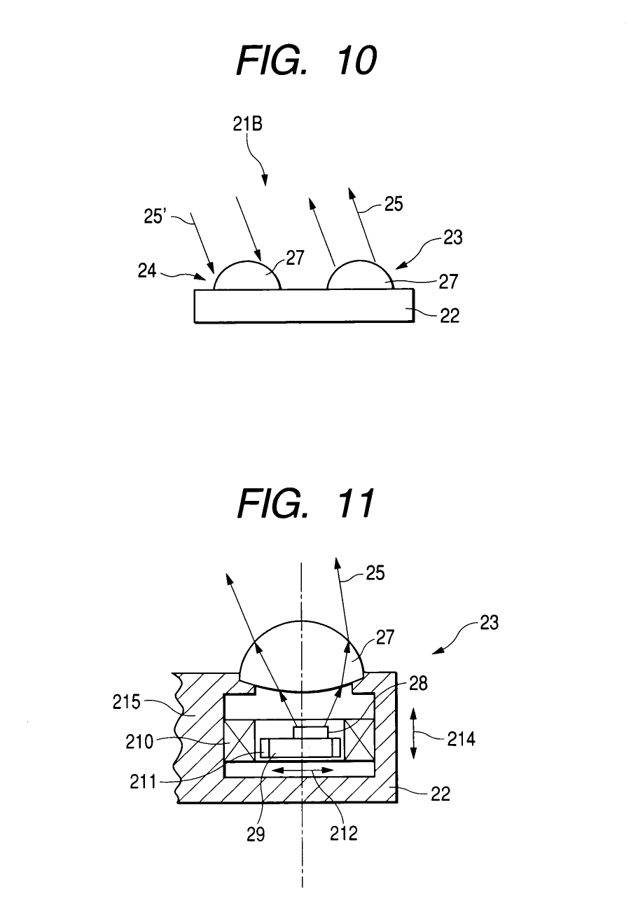

FIG. 10 shows the slave device 21B of the fourth embodiment. As shown in FIG. 10, the slave device 21B has the transmitting section 23 and the receiving section 24 which are disposed on a substrate 22. The transmitting section 23 transmits the transmission light 25, and the receiving section 24 receives the received light 25′. In the slave device 21B, the diameter of the transmitting section 23 and that of the receiving section 24 are set to 5 mm, in order to attain miniaturization. In the master device 21A, the diameter of the transmitting section 23 and that of the receiving section 24 are set to about 20 mm, in order to enhance converging efficiency. In each of the respective devices 21A and 21B, the transmitting section 23 and the receiving section 24 are placed on the substrate 22 while being separated from each other by a distance essentially equal to the respective diameter.

FIG. 11 shows the transmitting section 23 of the slave device 21B of the fourth embodiment. As shown in FIG. 11, the transmitting section 23 has a light-emitting element 28 which is formed from a GaAs-based semiconductor laser and disposed in the vicinity of the position of a focal point of a condenser lens 27. In the condenser lens 27, both a plane of incidence and a plane of exit are formed as aspheric surfaces. Aberration of the planes is abated, thereby imparting an essentially-Gaussian-shaped distribution to the transmission light 25. Further, the light-emitting element 28 is provided on an MEMS (Micro Electrical-Mechanical System) element 29, which can be electro-statically, two-dimensionally scanned, and is subjected to two-dimensional scannig. Moreover, the MEMS element 29 is disposed in a voice coil 210. By means of providing an electric current to the coil 210, a magnet 11 attached to the MEMS element 29 is actuated by electromagnetic force, whereupon a light-emitting element 28 is scanned in an axial direction 214 of a condenser lens 27. The directional angle of the transmission light 25 is adjusted. According to such a configuration, the directional angle can be deflected from 0° (a collimated beam) to 30°, and an exit direction can be deflected through about ±10°. A holder section 215 is provided on a part of the substrate 22 and retains the condenser lens 27, the MEMS element 29, or the like.

A GaAs VCSEL (Vertical Resonance Surface-Emitting Laser) having a wavelength of 850 nm is used for the light-emitting element 28 of the slave device 21B. An InGaAs LD (End-Face-Emitting Laser) which oscillates at a wavelength of 980 nm is used for the light-emitting element 28 of the master device 21A. An active layer of the VCSEL of the slave device 21B has a comparatively large diameter on the order of 10 μm. Although the VCSEL performs multimode oscillation, a large output; e.g., an output of 10 mW or more, can be produced. In order to curtail costs, an LD for fiber amplification purpose is used as the LD of the master device 21A. As a result of the transmission wavelength of the master device 21A and that of the slave device 21B having been made different from each other, the laser lights emitted from these devices can be separated from each other through use of simple color glass. The light-emitting element 28 of the slave device 21B is mounted on the MEMS element 29 capable of scanning in two dimensions 12, that is, directions X and Y. As a result, the transmission light source can be two-dimensionally scanned.

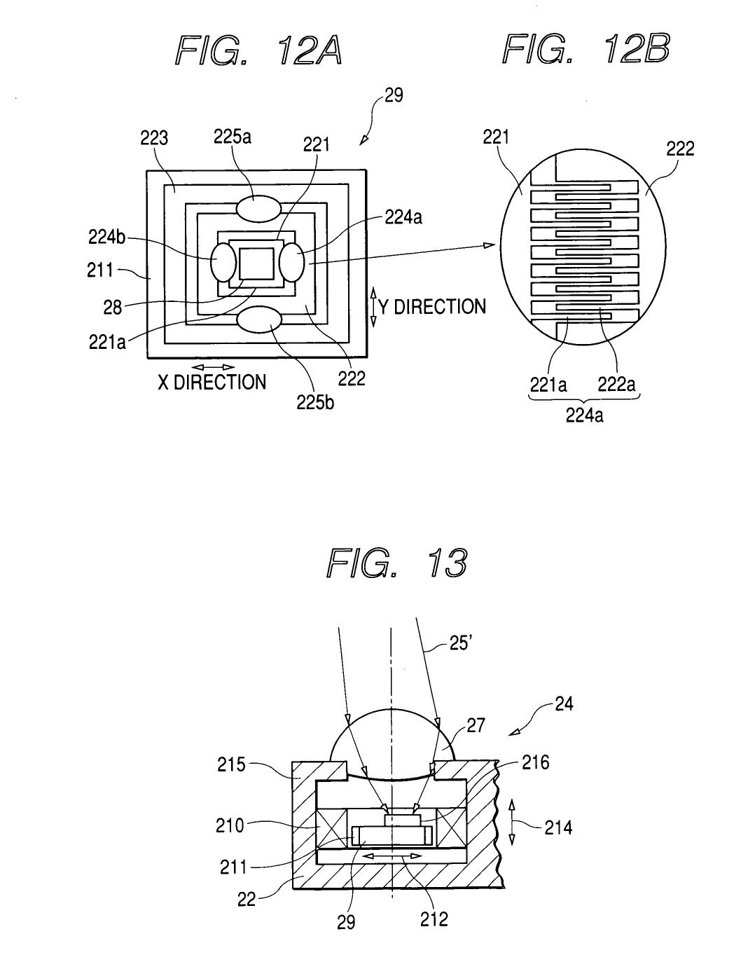

FIG. 12A shows the principal feature of the MEMS (Micro Electro-Mechanical System) element 29. The MEMS element 29 has an MEMS substrate 223 which is fixed to the magnet 211, a Y-direction movable section 222 which is movable in the direction Y with respect to the MEMS substrate 223, and an X-direction movable section 221 which is movable in the direction X with respect to the Y-direction movable section 222. The light-emitting element 28 is mounted at the center of the X-direction movable section 221. Saw-toothed drive elements 224a, 224b are disposed on the respective horizontal sides of the X-direction movable section 221 between the X-direction movable section 221 and the Y-direction movable section 222. Saw-toothed drive elements 225a, 225b are disposed on vertical sides of the Y-direction movable section 222 between the Y-direction movable section 222 and the MEMS substrate 223.

As shown in FIG. 12B, the saw-toothed drive element 224a is formed from a pair of saw-toothed electrodes 221a, 222a which extend in the X direction and have a width of 5 μm and a length of 150 μm. As a result of an electrostatic voltage being applied to the electrodes 221a, 222a from the element drive section 261, the saw-toothed drive element performs scanning in the X direction. The other saw-toothed drive element 224b is configured in the same manner as is the saw-toothed drive element 224a shown in FIG. 12B. As a result of an electrostatic voltage being applied to the electrodes from the element drive section 261, the saw-toothed drive element 224b performs scanning in the X direction. The saw-toothed electrode elements 225a, 225b are formed from a pair of saw-toothed electrodes which extend in the Y direction and have a width of 5 μm and a length of 150 μm. As a result of an electrostatic voltage being applied to the electrodes from the element drive section 261, the saw-toothed drive elements perform scanning in the Y direction. As a result of the light-emitting element 28 being actuated in the X and Y directions, the light-emitting element 28 is actuated over a distance of ±100 μm, and outgoing light is two-dimensionally scanned through an angle of 10° or thereabouts.

FIG. 13 shows the receiving section 24 of the slave device 21B of the first embodiment. As shown in FIG. 13, the receiving section 24 differs from the transmitting section shown in FIG. 11 only in that the light-emitting element 28 is replaced with a light-detecting element 216. In other respects, the receiving section 24 is configured in the same manner as is the transmitting section 23. The light-detecting element 216 formed from two-dimensional arrayed pin photodiodes is disposed on the MEMS element 29.

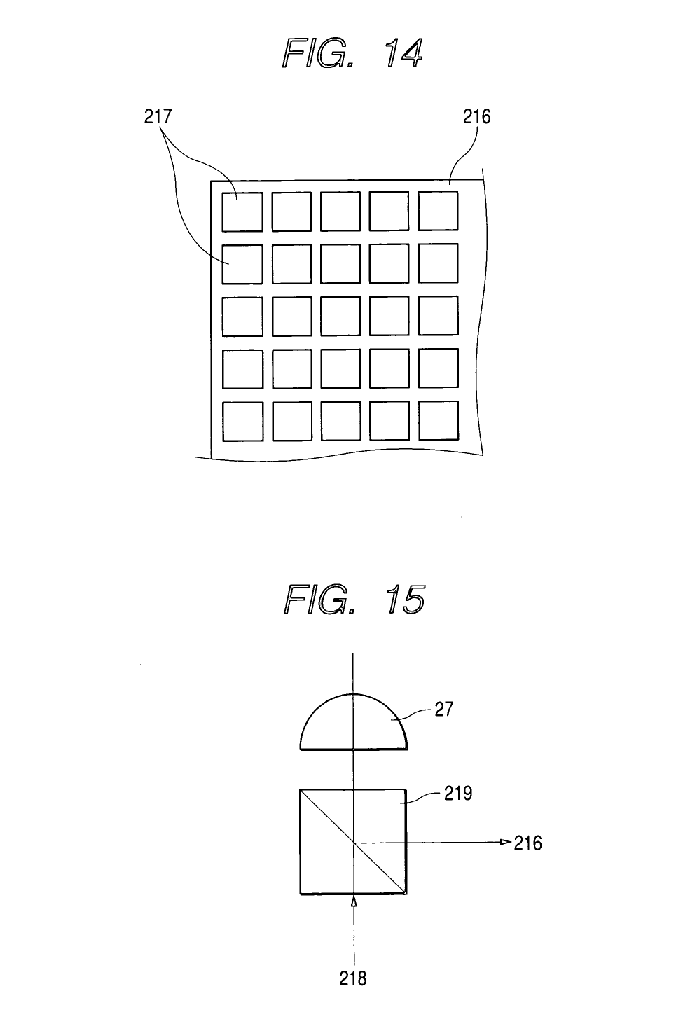

FIG. 14 shows a light-detecting element 216 of the light-detecting section 24 according to the fourth embodiment. The light-detecting element 216 is configured from a two-dimensional array having 20-by-20 pin photodiodes 217, each photodiode being measuring 5 μm square. The light-detecting element 216 is disposed on the MEMS element 29, which can be two-dimensionally scanned in X and Y directions, and is subjected to two-dimensional scanning.

As mentioned above, received light 25′ is converged to the light-detecting element 216. In addition, in a state shown in FIG. 9B, the distribution of converging intensity is measured, whereby the three-dimensional position calculation section 260 computes a three-dimensional position of the transmitting section 23 of the received light 25′. On the basis of the result of computation, the light-detecting element 216 is positioned in the X and Y directions. Moreover, the light-detecting element 216 is scanned by an element drive section 261, whereby light is converted on one limited pin photodiode 217 (or a small number of pin photodiodes, such as two to four pin photodiodes) in the array, thereby enabling high-sensitivity, high-speed signal processing.

According to the fourth embodiment, only the light-emitting element 28 and the light-detecting element 216 are scanned while the condenser lens 27 remains fixed, thereby enabling a significant reduction in the size of a movable section. The wireless optical system can be significantly miniaturized to a size of 1 cm or less, and high-speed scanning also becomes feasible. Further, the light-emitting element 28 and the light-detecting element 216 are scanned, and the directional angles for transmission and reception are also changed. As a result, transmission light having a wide directional angle can be used at the time of initiation of transmission and reception operations. Consequently, transmission and reception operations can be initiated more reliably. During the course of transmission and reception of data, transmission light having a narrow directional angle and a low output is transmitted. As a result, the quantity of light entering the light-detecting element 216 can be increased, and high-speed, high-sensitivity transmission and reception becomes feasible. Accordingly, the wireless optical system can be applied to mobile equipment.

(Fifth Embodiment)

FIG. 15 shows an optical wireless device according to a fifth embodiment of the present invention. The fifth embodiment is based on the fourth embodiment, wherein the light-emitting element 28 and the light-detecting element 216 are disposed in the vicinity of the condenser lens 27 so as to transmit and receive by way of a common beam splitter 219 and the common condenser lens 27. According to the fifth embodiment, the position of the light-emitting element 28 and that of the light-detecting element 216 are scanned with respect to the common condenser lens 27. The transmitting section and the receiving section are assembled into a single unit such that transmission is performed by controlling the transmitting and reception directions and the directional angle. As a result, the optical wireless device can be made compact to a much greater extent.

The present invention is not limited to the fourth and fifth embodiments set forth and is susceptible to various modifications. For instance, a CCD (Charge-Coupled Device) array may be used instead of the pin photodiode array as the light-detecting element 216, thereby enabling an attempt to curtail costs. However, in this case, signal processing is required to be carried out on a per-row basis in order to achieve enhanced speed.

In the embodiments, the light-emitting element 28 and the light-detecting element 216 are electro-statically scanned. However, if the MEMS element 29 is equipped with an electromagnet, the light-emitting element 28 may be electro-magnetically scanned. Alternatively, the light-emitting element 28 and the light-detecting element 216 may be supported through use of four narrow plate springs, which are used for automatic focus control and tracking in a pickup for use with an optical disk, in place of the MEMS element 29, and electro-magnetically scanned. As a result, scanning can be performed over hundreds of micrometers, and the directional angle can be changed significantly. Even when a large-diameter lens is used, a receiving angle can be scanned at a sufficient angle, and high-sensitivity receiving becomes feasible.

The light-emitting element 28 may be stacked on the light-detecting element 216. As a result, an attempt can be made to make the wireless optical system more compact. In this case, an interference filter for interrupting the transmission light 25 is preferably interposed between the light-emitting element 28 and the light-detecting element 216 so that the light transmitted from the light-emitting element 28 does not enter the light-detecting element 216. As a result, bi-directional communication between the master device 21A and the slave device 21B becomes feasible.

The condenser lens 27 may be shifted with respect to the light-emitting element 28 or the light-detecting element 216.

According to the above embodiments, the master device 21A or the slave device 21B on one end can be caused to track movement of the slave device 21B or the master device 21A on the other end. Therefore, these can be applied to high-speed communication attained by mobile equipment, such as a PDA or a portable cellular phone.

1. A wireless optical system which comprises a transmitting section having a light-emitting element and a transmission light condenser lens, and a receiving section having a light-detecting element and a received light condenser lens, and which communicates with a counterpart device, the wireless optical system further comprising:
scanning means which scans said light-emitting element relative to said transmission light condenser lens; and
control means which controls a transmission direction of transmission light transmitted from said light-emitting element by driving said scanning means.

2. A wireless optical system which comprises a transmitting section having a light-emitting element and a transmission light condenser lens, and a receiving section having a light-detecting element and a received light condenser lens, and which communicates with a counterpart device, the wireless optical system further comprising:
scanning means which scans said light-detecting element relative to said received light condenser lens; and
control means which controls a reception direction of received light received by said light-detecting element by driving said scanning means.

3. A wireless optical system which comprises a transmitting section having a light-emitting element and a transmission light condenser lens, and a receiving section having a light-detecting element and a received light condenser lens, and which communicates with a counterpart device, the wireless optical system further comprising:
scanning means which scans said light-emitting element relative to said transmission light condenser lens, and scans said light-detecting element relative to said received light condenser lens; and
control means which controls a transmission direction of transmission light transmitted from said light-emitting element by driving said scanning means, and controls a reception direction of received light received by said light-detecting element by driving said scanning means.

4. A wireless optical system which comprises a transmitting section according to claim 1, said scanning means two-dimensionally scans said light-emitting element.

5. A wireless optical system which comprises a transmitting section according to claim 2, said scanning means two-dimensionally scans said light-detecting element.

6. A wireless optical system which comprises a transmitting section according to claim 3, said scanning means two-dimensionally scans said light-emitting element and two-dimensionally scans said light-detecting element.

7. The wireless optical system according to claim 4, wherein one common condenser lens is used as both said transmission light condenser lens and said received light condenser lens, and
said light-emitting element and said light-detecting element are disposed such that the transmission light and the received light are transmitted and received through said common condenser lens.

8. The wireless optical system according to claim 5, wherein one common condenser lens is used as both said transmission light condenser lens and said received light condenser lens, and
said light-emitting element and said light-detecting element are disposed such that the said transmission light and the received light are transmitted and received through said common condenser lens.

9. The wireless optical system according to claim 6, wherein one common condenser lens is used as both said transmission light condenser lens and said received light condenser lens, and
said light-emitting element and said light-detecting element are disposed such that the said transmission light and the received light are transmitted and received through said common condenser lens.

10. The wireless optical system according to claim 5, wherein said light-detecting element includes a plurality of light-detecting cells arranged in a two-dimensional array, and
said control means drives said scanning means to limit said light-detecting cells to one or a small number of cells which receive light among the plurality of light-detecting cells.

11. The wireless optical system according to claim 6, wherein said light-detecting element includes a plurality of light-detecting cells arranged in a two-dimensional array, and
said control means drives said scanning means to limit said light-detecting cells to one or a small number of cells which receive light among the plurality of light-detecting cells.

12. The wireless optical system according to claim 10, wherein the plurality of light-detecting cells are configured from a plurality of CCDs or MOS elements.

13. The wireless optical system according to claim 10, wherein the plurality of light-detecting cells are configured from a plurality of photodiodes or avalanche photodiodes.

14. The wireless optical system according to claim 4, wherein said light-detecting element is disposed in vicinity of a focal point of said received light condenser lens, and is configured from a single light detecting element which is equal in size to a diameter of a light-condensed spot formed by said received light condenser lens.

15. The wireless optical system according to claim 5, wherein said light-detecting element is disposed in vicinity of a focal point of said received light condenser lens, and is configured from a single light detecting element which is equal in size to a diameter of a light-condensed spot formed by said received light condenser lens.

16. The wireless optical system according to claim 6, wherein said light-detecting element is disposed in vicinity of a focal point of said received light condenser lens, and is configured from a single light detecting element which is equal in size to a diameter of a light-condensed spot formed by said received light condenser lens.

17. The wireless optical system according to claim 4, wherein said light-detecting element is disposed in vicinity of a focal point of said received light condenser lens, and is constituted from a pair of light detecting elements which are equal in size to a diameter of a light-condensed spot formed by said received light condenser lens.

18. The wireless optical system according to claim 5, wherein said light-detecting element is disposed in vicinity of a focal point of said received light condenser lens, and is constituted from a pair of light detecting elements which are equal in size to a diameter of a light-condensed spot formed by said received light condenser lens.

19. The wireless optical system according to claim 6, wherein said light-detecting element is disposed in vicinity of a focal point of said received light condenser lens, and is constituted from a pair of light detecting elements which are equal in size to a diameter of a light-condensed spot formed by said received light condenser lens.

20. The wireless optical system according to claim 4, wherein said light-emitting element is formed to be stacked on said light-detecting element.

21. The wireless optical system according to claim 5, wherein said light-emitting element is formed to be stacked on said light-detecting element.

22. The wireless optical system according to claim 6, wherein said light-emitting element is formed to be stacked on said light-detecting element.

23. The wireless optical system according to claim 14, wherein
said scanning means periodically wobbles a position of said single light detecting element; and
said control means generates a positional error signal pertaining to a transmission direction of a counterpart device by means of detecting the received light in synchronization with a wobbling cycle of said single light detecting element, and optimizes transmission and reception directions based on the positional error signal.

24. The wireless optical system according to claim 15, wherein
said scanning means periodically wobbles a position of said single light detecting element; and
said control means generates a positional error signal pertaining to a transmission direction of a counterpart device by means of detecting the received light in synchronization with a wobbling cycle of said single light detecting element, and optimizes transmission and reception directions based on the positional error signal.

25. The wireless optical system according to claim 16, wherein
said scanning means periodically wobbles a position of said single light detecting element; and
said control means generates a positional error signal pertaining to a transmission direction of a counterpart device by means of detecting the received light in synchronization with a wobbling cycle of said single light detecting element, and optimizes transmission and reception directions based on the positional error signal.

26. An optical wireless system which communicates between a master device and a slave device, wherein
said master device and said slave device respectively comprise a transmitting section having a light-emitting element and a transmission light condenser lens, and a receiving section having a light-detecting element and a received-light condenser lens, and
at least one of said master device and said slave device comprises:
scanning means which two-dimensionally scans said light-emitting element relative to said transmission light condenser lens, and two-dimensionally scans said light-detecting element relative to said received light condenser lens;
measuring means which measures a transmission direction of the transmission light transmitted from said master device or said slave device on the other end; and
control means which drives said scanning means to control a transmission direction of the transmission light transmitted from said light-emitting element and a reception direction of the received light received by said light-detecting element based on measurement result of said measuring means.

27. The wireless optical system according to claim 26, wherein said light-emitting elements of said master device and said slave device emit the transmission light at different wavelengths.

28. The wireless optical system according to claim 27, wherein said light-emitting element of said slave device emits the transmission light at a wavelength which is shorter than that of the transmission light emitted from said light-emitting element of said master device.

29. The wireless optical system according to claim 27, wherein said light-emitting element of said master device emits the transmission light having a wavelength of 1.4 to 1.6 μm, and
said light-emitting element of said slave device emits the transmission light having a wavelength of 0.8 to 1 μm.

30. The wireless optical system according to claim 26, wherein at least one of said master device and said slave device detects a direction of the transmission light emitted from said master device or said slave device on the other end, and communicates by transmitting the transmission light in the direction of the transmission light.

31. The wireless optical system according to claim 26, wherein said slave device two-dimensionally scans said light-emitting element, and
said master device measures a direction of the transmission light and communicates by transmitting the transmission light in the direction.

32. The wireless optical system according to claim 1, wherein said control means also controls a directional angle of the transmission light by means of driving said scanning means.

33. The wireless optical system according to claim 3, wherein said control means also controls a directional angle of the transmission light by means of driving said scanning means.

34. The wireless optical system according to claim 2, wherein said control means also controls a directional angle of the received light by means of driving said scanning means.

35. The wireless optical system according to claim 3, wherein said control means also controls a directional angle of the received light by means of driving said scanning means.

36. The wireless optical system according to claim 1, wherein one common condenser lens is used as both said transmission light condenser lens and said received light condenser lens, and
said light-emitting element and said light-detecting element are disposed such that the transmission light transmitted from said light-emitting element and the received light received by said light-detecting element are transmitted and received through said common condenser lens.

37. The wireless optical system according to claim 2, wherein one common condenser lens is used as both said transmission light condenser lens and said received light condenser lens, and
said light-emitting element and said light-detecting element are disposed such that the transmission light transmitted from said light-emitting element and the received light received by said light-detecting element are transmitted and received through said common condenser lens.

38. The wireless optical system according to claim 3, wherein one common condenser lens is used as both said transmission light condenser lens and said received light condenser lens, and
said light-emitting element and said light-detecting element are disposed such that the transmission light transmitted from said light-emitting element and the received light received by said light-detecting element are transmitted and received through said common condenser lens.

39. The wireless optical system according to claim 1, wherein said light-emitting element is disposed in vicinity of a position of a focal point of said transmission light condenser lens,
said scanning means supports said light-emitting element in a three-dimensionally movable manner, and
said control means controls a transmission direction and a directional angle of the transmission light, by means of driving said scanning means to three-dimensionally move said light-emitting element.

40. The wireless optical system according to claim 3, wherein said light-emitting element is disposed in vicinity of a position of a focal point of said transmission light condenser lens,
said scanning means supports said light-emitting element in a three-dimensionally movable manner, and
said control means controls a transmission direction and a directional angle of the transmission light, by means of driving said scanning means to three-dimensionally move said light-emitting element.

41. The wireless optical system according to claim 2, wherein said light-detecting element is disposed in vicinity of a position of a focal point of said received light condenser lens,
said scanning means supports said light-detecting element in a three-dimensionally movable manner, and said control means controls a reception direction and a directional angle of the received light, by means of driving said scanning means to three-dimensionally move said light-detecting element.

42. The wireless optical system according to claim 3, wherein said light-detecting element is disposed in vicinity of a position of a focal point of said received light condenser lens,
said scanning means supports said light-detecting element in a three-dimensionally movable manner, and said control means controls a reception direction and a directional angle of the received light, by means of driving said scanning means to three-dimensionally move said light-detecting element.

43. The wireless optical system according to claim 2, wherein said light-detecting element includes a plurality of light-detecting cells arranged in a two-dimensional array, and
said control means drives said scanning means to limit said light-detecting cells to one or a small number of cells which receive light among the plurality of light-detecting cells.

44. The wireless optical system according to claim 3, wherein said light-detecting element includes a plurality of light-detecting cells arranged in a two-dimensional array, and
said control means drives said scanning means to limit said light-detecting cells to one or a small number of cells which receive light among the plurality of light-detecting cells.

45. An optical wireless system which communicates between a master device and a slave device, wherein
said master device and said slave device respectively comprise a transmitting section having a light-emitting element and a transmission light condenser lens, and a receiving section having a light-detecting element and a received-light condenser lens, and
at least one of said master device and said slave device comprises:
scanning means which scans said light-emitting element relative to said transmission light condenser lens, and scans said light-detecting element relative to said received light condenser lens; and
control means which drives said scanning means to control said transmission direction of the transmission light transmitted from said light-emitting element and a reception direction of the received light received by said light-detecting element.

46. The wireless optical system according to claim 45, wherein said transmitting section of at least one of said master device and said slave device transmits transmission light having a wide directional angle, and
said receiving section of a remaining device receives the transmission light having a wide directional angle, and starts a communication with said transmitting section.

47. The wireless optical system according to claim 45, wherein said transmitting section of at least one of said master device and said slave device transmits transmission light having a wide directional angle, and
said receiving section of a remaining device receives the transmission light having a wide directional angle, and starts a communication with said transmitting section, and
wherein, subsequently, said transmitting section or said receiving section performs the communication by means of narrowing a directional angle of the transmission light or the received light.
